(19) United States
(12) Patent Application Publication
(10) Pub. No.: US 2019/0382612 A1
(43) Pub. Date: Dec. 19, 2019

(54) ARCHITECTURAL COATING COMPOSITION CONTAINING HIGH RATIO SOLUBLE SILICATES

(71) Applicant: PQ Corporation, Malvern, PA (US)

(72) Inventors: Flavio Ernesto Ribeiro, Plainfield, IL (US); Ronaldo Dos Santos Flor, Sao Paulo (BR); Carlos Henrique Batista, Rio Claro (BR)

(21) Appl. No.: 16/488,981

(22) PCT Filed: Feb. 8, 2018
(86) PCT No.: PCT/US2018/017427

§ 371 Date: Aug. 27, 2019

Related U.S. Application Data
(60) Provisional application No. 62/464,673, filed on Feb. 28, 2017.

(51) Int. Cl. C09D 125/14; C09D 133/04; C09D 7/43

(52) U.S. Cl. CPC C09D 125/14; C09D 7/43; C09D 133/04

(57) ABSTRACT

A water-based paint production process and product reduces costs by replacing at least a portion of the resin with high ratio soluble silicates having a SiO₂:Na₂O or SiO₂:K₂O weight ratio that is higher than 3.3 for sodium silicates and higher than 2.4 for potassium silicates. The high ratio soluble silicate is used as a co-binder for minimizing the costs involved with the use of resin in paint. Use of the high ratio soluble silicate maintains the scrub resistance of the paint and eliminates the need for a pH stabilizing agent, leading to a proportional reduction in the coalescing agent. Because of the complex structures formed by silicates of high weight ratio, the viscosity of the paints will increase, reducing the demand for thickeners. Replacing the organic resins with inorganic soluble silicates lowers the amount of volatile substances in paints, providing more environmentally friendly paint compositions.

### CROSS-REFERENCE TO RELATED APPLICATION

This application claims priority to U.S. Provisional Application Ser. No. 62/464,673 filed on Feb. 28, 2017 entitled “Architectural Coating Composition Containing High Ratio Soluble Silicates”, the full disclosure of which is disclosed herein.

### BACKGROUND TO THE INVENTION

### Field of the Invention

This invention is directed at the architectural coatings market, including soluble silicates with a SiO₂:Na₂O or SiO₂:K₂O weight ratio that is higher than 3.3 for sodium silicates and higher than 2.4 for potassium silicates. Soluble silicates with a high ratio maximize polymerization performance, primarily when used as a co-binder, and can be used as a replacement for emulsions or resins, such as acrylic, vinyl acrylic, styrene acrylic, polyvinyl acetate or similar substances. These binders, or co-binders, may be used, for example, for application in architectural coatings as part of a formula designated for specific uses, such as roof coatings, wall paints (internal and external), and deck finishes. No matter its use, each architectural coating must provide certain decorative, durable, and protective functions.

### Description of the Related Art

Binders or emulsions are commercialized worldwide as the film-forming component of paint and they are the only components that are always present in all the various types of formulation. The binder imparts properties such as gloss, durability, flexibility, and toughness to acrylics, vinyl-acrylics, vinyl ethylene acetate or polyvinyl acetate for water-based application. Both resins and emulsions are found in many applications, for example in civil construction, paints, wood, plastics, and adhesives, and their cost is very significant. Therefore, any technical alternative is important considering the demand for these products and the fact that the consequence of reducing the amount of resin used will have an impact on the coalescence content in the formula which is directly and proportionally linked to resin content. So any reduction in resin will result in a proportional reduction in the coalescent agent resulting in additional cost savings. Moreover, if the reduction in resin is accomplished by the addition of an inorganic compound, the level of volatile organic compounds in the formula that cause environmental impact will be reduced.

### SUMMARY OF THE INVENTION

The amount of emulsion or resin in formulas can be reduced by replacement with inorganic compounds, such as co-binders, so long as the proprieties provided by resins, such as gloss, durability, flexibility, and toughness, are preserved. A proper balance of the formula is very important for providing the needed competitiveness and performance.

It has been found that the addition of high ratio soluble silicates offers lower costs by the partial replacement of resins with the soluble silicate, while maintaining desired performance qualities. An example of the importance of this is the huge number of types of resin and emulsion in the market with different qualities.

The present invention is a new alternative, providing options via the chemistry of soluble silicates for producing for the market a co-binder with a high performance, considering that the addition and cost of resins are among the most significant items in the formula and of particular concern to the producers

The soluble silicate should also provide the degree of alkalinity needed for paint formulas based on alkalinity provided by sodium oxide content and also can potentially reduce the demand for thickeners due to polymerization process for soluble silicate linked to silicon dioxide content, which will lead to additional cost savings by reducing or eliminating pH stabilizers and thickening agents. In addition, soluble silicates can improve scrub resistance, inhibit corrosion, leveling and are environmentally friendly.

### BRIEF DESCRIPTION OF THE DRAWINGS

FIG. 1 is a graph depicting the effect of the concentration of high ratio silicates on the pH of the paint composition.

FIG. 2 is a graph depicting the effect of the concentration of high ratio silicates on the required dosage of thickener needed for the paint composition.

### DETAILED DESCRIPTION OF THE INVENTION

The present invention is directed at the architectural coatings industry segment relating to interior and exterior paints. The current invention considers replacing resins, such as acrylics, vinyl acrylics, vinyl ethylene acetate, polyvinyl acetate, and similar substances, with high ratio soluble silicates.

Soluble silicates are substances containing varying proportions of an alkali metal and silica (SiO₂), usually with at least some water. Soluble sodium silicates are a chemical compound of silicon dioxide (SiO₂) and sodium oxide (Na₂O). The commonest commercial silicates correspond to weight ratio values of silicon dioxide to alkali metal oxide in the range of 1.5 and 3.2 for sodium silicates. Intermediate ratios may be made by mixing, and more alkaline grades may be made by adding caustic soda. High ratio soluble silicates are those with a weight ratio of silicon dioxide to alkali metal oxide that is higher than 3.3 for sodium silicate or higher than 2.4 for potassium silicate.

Soluble silicates are one of the oldest and most benign industrial chemicals. One reason for the early development of soluble silicate was the relatively simple process for manufacturing it. Sodium (or potassium) silicates are manufactured by fusing sand (SiO₂) with sodium or potassium carbonate (Na₂CO₃ or K₂CO₃) at 1100-1200° C. The resulting glass can be dissolved by high pressure steam to form a clear, slightly viscous liquid known as waterglass.

The most important property of sodium silicate is the SiO₂:Na₂O weight ratio. Silicates are commercially produced in the ratio range of 1.5 to 3.2. The ratio represents an average of the various molecular weights of silicate species and the solubility rate must be controlled due to the narrow range for keeping it stable.

The silicate ratio dictates which silicate species is dominant in the solution. It is at this molecular level that such things as rate of gelation, precipitation, dehydration, water resistance, polymerization performance etc. are determined [Vail J. G., “Soluble Silicate, Their Properties and Uses”, Reinhold Publishing Corp. 1952]. With respect to the co-binder effect, when the content difference of silicon dioxide is greater than that of sodium oxide, more complex structures are expected. High ratio silicates can be used as film-forming agents together with emulsions as a co-binder. The high ratio soluble silicates can partially replace the resin content in the formula.

The polymerization of soluble silicates occurs rapidly when the pH of liquid silicate falls below 9.7 and the silicate species begins crosslinking to form polymers. Although the bond formed by the polymerized silicate is not as strong as the bond formed by dehydration, it has a higher degree of water resistance. This reaction can play a role in agglomeration when the surface of the material being agglomerated is acidic, or the material being agglomerated is exposed to an environment high in CO₂ and it is faster considering the increase in the weight ratio between silicon dioxide and the alkali metal oxide. The film formed by soluble silicates is inert and its solubility is inversely proportional to soluble silicates with a higher weight ratio.

According to the current process and the raw materials used, the partial replacement of resins with high ratio soluble salts is expected to result in lower costs with respect to formulas using soluble silicates with a high ratio when compared to common binders, such as acrylics, vinyl acrylics, vinyl ethylene acetate, or polyvinyl acetate, without any replacement of these binders by soluble silicates with a high ratio.

This invention aims to test the effect of high ratio soluble silicates in order to maximize the known effect provided by silicon dioxide as a polymer and, consequently, as a co-binder that is noticed when the weight ratio is increased to a maximum. Tests were carried out using typical formulas found in the Brazilian market, such as Coral® paint sold under the “Rende Muito” brand, made by AkzoNobel, Mauá., S P, Brazil, and Suvinil® paint made by BASF, S. B. Campo, Brazil. The replacement was done directly in the formula and all the proprieties were measured in accordance with market needs. Based on current market prices for resins when compared with the production cost for soluble silicates, a considerable cost savings was obtained when resins were replaced by soluble sodium silicates with ratios higher than 3.3. The proprieties of the paint were maintained.

Development is aimed at soluble sodium silicates with a ratio higher than 3.3 in order to avoid increasing the soluble salts content, which is prejudicial to paints such as efflorescence with direct impact with respect to durability in paints with intense colors, caused by soluble salts and to promote a better film quality according to the chemistry for soluble silicates. [LIler R. K., “The Chemistry of Silica”, John Wiley & Sons Inc., 1979].

### Methodology for Paint Preparation

The present invention comprises a replacement process method when the paint is being produced, but can be used with any other production or application method. As a simulated production example, this invention can be used in water-based paints for application on brick or concrete walls. With regard to paint production, there is no difference in the process. However, due to the incremental build-up, it is recommended that in the early production process the addition of thickeners is controlled because a certain increase in the initial viscosity is expected based on the higher polymerization effect noted for this range of sodium silicates with a high weight ratio when compared with other silicates with a lower weight ratio.

With regard to the paint production flow process, there are no additions or changes to the common production steps, such as weighing the raw materials, dispersing or milling the mineral or synthetic fillers, storage and shipment in general. This group of soluble silicates with a high weight ratio can be added together with the resin without damaging or adversely affecting the other regular components, such as thickeners, coalescents, mineral fillers, biocides, fungicides, dispersants and others.

### Composition

The paint compositions outlined herein include soluble silicates with a weight ratio higher than 3.3. These soluble silicates act as co-binders for replacing resin or as an additional binder, depending on what proprieties or objectives are desired. Embodiments may include fillers, such as kaolin, calcite and titanium dioxide, but there are no adverse effects if one or more fillers, resin binders (either a single binder or a combination of binders), and a thickener are used in the same formula.

Other components or additives may also be added to give specific functionality to this invention. These may include, for example, pigments, solvents, plasticizers, emulsions, preservatives, surfactants (dispersive), deformers, alkalizing agents and anti-corrosive agents, but are not limited to such. Those skilled in the art of paint production will recognize that the composition may include other additives that are conventionally used in production, so long as the nature of these compositions is not compromised due to any incompatibility between components, or wrong decisions taken with regard to the balance of the formula, such as the ratio of binders and co-binders versus the amount of fillers used.

Components and additives may be present in a powder or liquid form. They can be water or oil soluble, involve natural or synthetic compounds and be safe to use. Other variations and combinations of different components with the addition of sodium silicates with a high weight ratio are within the scope and spirit of the present invention.

Soluble silicates with a high weight ratio are typically included as a co-binder to extend the binder effect in paints. Without soluble silicates the composition lacks a number of favorable opportunities for reducing costs by replacing resins, because the other option, which is the reduction of resin and the inclusion of mineral fillers, will certainly have an impact on film-forming due to the change in the ratio between them (binders, co-binders) as compared with fillers having adverse effects such as scrub resistance, gloss, scrub resistance and other proprieties. The amount of dry solid content may vary from about 0.1% to about 50% by weight, but is preferably present in an amount from 1% to 49% by weight. The soluble silicates are able to replace the resin from 0.01% up to 50% according to amount of resin used in paints.

The resin binder may be used as only one component or a multiple combination of different resin binders. Resin binders include any binder known in the paint market. For example, they may include substances in the group of organic polymers (such as vinyl acetate, styrene acrylic, vinyl acrylic and acrylic) or combinations thereof, in a powder or liquid form, water-soluble or oil-soluble, and natural or synthetic products. The amount of resin binder as dry solid content may range from about 0.1% to about 50% by weight, but is preferably present in an amount between 1% and 49% by weight. An example of a resin binder is the aqueous dispersion of a styrene acrylic copolymer, which is marketed as BS 700™ resin by BASF Resinas of Sao Paulo, Brazil.

Pigments can be any compound that imparts color to the paint. They may include components that are organic or inorganic substances, in a powder or liquid form, water or oil soluble, natural or synthetic, such as carbon black, titanium dioxide and many others.

A thickener may be necessary to give the desired rheology or viscosity to the paint for a specific purpose of an embodiment of the present invention. Embodiments of the invention typically include water as a solvent. This will decrease the amount of volatile organic content (VOC) in the composition. The solvent may be present in an amount between about 0.01-90% by weight, but preferably from 30-50% by weight, or 65-85% by weight. Other polar or nonpolar solvents, which may be either water or oil-soluble, are within the scope of this invention.

Other components (like surfactants, defoamers, alkalizing and anti-corrosive agents and preservatives), in a powder or liquid form, water or oil soluble, and natural or synthetic products, may be used to add specific functionality to the paint. A defoaming agent may be used to reduce or eliminate the air bubbles that form during the production process of paints and that are mainly generated by the use of surfactants.

A preservative agent may be used to prevent in-can contamination or after-application contamination of the dry film.

### EXPERIMENTAL

In order to test the effectiveness of a high ratio silicate as an extender for resin in a latex paint formulation, a series of paint formulations were prepared. First, a typical latex paint formula used in Brazil (Paint 1) was prepared having the formulation set forth in Table 1 below:

TABLE 1

| | Weight | Weight |
|---|---|---|
| | % | (kg) |
| sodium tripolyphosphate (FT 031 - Quimidrol) | 0.05% | 0.50 |
| pH Stabilizer (Ammonia) | 0.30% | 3.00 |
| Sodium Nitrite (EM-392 Cosmoquimica) | 0.05% | 0.50 |
| Dispersant (Sodium Polyacrylate (Polysal ® BA) | 0.30% | 3.00 |
| Moist agent (LIOVAC ® 504 Miracema) | 0.15% | 1.50 |
| Antifoam (LIOFAM 152 - Miracem) | 0.20% | 2.00 |
| Bactericide (Acticide BR 7530 - Thor) | 0.20% | 2.00 |
| Coalescing agent (Texanol - Eastman) | 0.40% | 4.00 |
| Thickener (acrylic Viscolam PS 202) - Lamberti | 0.90% | 9.00 |
| Fungicide (Korina 253 -Miracema) | 0.25% | 2.50 |
| Resin(BS 700 - BASF) | 12.00% | 120.00 |
| Water | 47.80% | 478.00 |
| TiO₂ (R902 Chemours) | 8.00% | 80.00 |
| Calcita(Brasilminas) | 8.50% | 85.00 |
| Calcium Carbonate precipitated (Brasilminas) | 10.50% | 105.00 |
| kaolin (Brasilminas) | 10.40% | 104.00 |

A second latex paint formulation (Paint 2) was prepared in which 30% of the resin in Paint 1 was replaced with high ratio silicate. The formulation for this modified paint is set forth in Table 2 below:

TABLE 2

| | Weight | Weight |
|---|---|---|
| | % | (kg) |
| sodium tripolyphosphate (FT 031 - Quimidrol) | 0.05% | 0.50 |
| Sodium Nitrite (EM-392 Cosmoquimica) | 0.05% | 0.50 |
| Dispersant (Sodium Polyacrylate (Polysal ® BA) | 0.30% | 3.00 |
| Moist agent (LIOVAC ® 504 Miracema) | 0.15% | 1.50 |
| Antifoam (LIOFAM 152 - Miracem) | 0.20% | 2.00 |
| Bactericide (Acticide BR 7530 - Thor) | 0.20% | 2.00 |
| Coalescing agent (Texanol - Eastman) | 0.40% | 4.00 |
| Thickener (acrylic Viscolam PS 202) - Lamberti | 0.90% | 9.00 |
| Fungicide (Korina 253 -Miracema) | 0.25% | 2.50 |
| Resin(BS 700 - BASF) | 8.40% | 84.00 |
| Sodium Silicate of high weight ratio | 3.60% | 36.00 |
| Water | 47.80% | 478.00 |
| TiO₂ (R902 Chemours) | 8.00% | 80.00 |
| Calcita(Brasilminas) | 8.50% | 85.00 |
| Calcium Carbonate precipitated (Brasilminas) | 10.50% | 105.00 |
| kaolin (Brasilminas) | 10.70% | 107.00 |

A third latex paint formulation (Paint 3) was prepared in which 30% of the resin in Paint 1 was replaced with water. The formulation for this modified paint is set forth in Table 3 below:

TABLE 3

| | Weight | Weight |
|---|---|---|
| | % | (kg) |
| sodium tripolyphosphate (FT 031 - Quimidrol) | 0.05% | 0.50 |
| pH Stabilizer (Ammonia) | 0.30% | 3.00 |
| Sodium Nitrite (EM-392 Cosmoquimica) | 0.05% | 0.50 |
| Dispersant (Sodium Polyacrylate (Polysal ® BA) | 0.30% | 3.00 |
| Moist agent (LIOVAC ® 504 Miracema) | 0.15% | 1.50 |
| Antifoam (LIOFAM 152 - Miracem) | 0.20% | 2.00 |
| Bactericide (Acticide BR 7530 - Thor) | 0.20% | 2.00 |
| Coalescing agent (Texanol - Eastman) | 0.40% | 4.00 |
| Thickener (acrylic Viscolam PS 202) - Lamberti | 0.90% | 9.00 |
| Fungicide (Korina 253 -Miracema) | 0.25% | 2.50 |
| Resin(BS 700 - BASF) | 8.40% | 84.00 |
| Water | 51.40% | 514.00 |
| TiO₂ (R902 Chemours) | 8.00% | 80.00 |
| Calcita(Brasilminas) | 8.50% | 85.00 |
| Calcium Carbonate precipitated (Brasilminas) | 10.50% | 105.00 |
| kaolin (Brasilminas) | 10.40% | 104.00 |

Tests were performed under Brazilian Technical Standard (NBR) 15079 on the paint formulations set forth in Tables 1-3 above. The paints were tested for their scrub resistance under NBR 14940; their productivity or dry opacity under NBR 14942; and their wet opacity under NBR 14943. In addition, the specific gravity of each paint formulation was measured at 25° C. The results of these tests are set forth in Table 4 below:

TABLE 4

| Test | Paint 1 | Paint 2 | Paint 3 |
|---|---|---|---|
| Scrub resistance (Number of cycles) | 43.8 | 44.2 | 23.00 |
| Productivity or dry opacity (M²/liter) | 5.3 | 5.3 | 5.3 |
| Wet opacity (%) | 86.3 | 86.3 | 86.3 |
| Specific gravity (g/cm³) | 1.31 | 1.33 | 1.31 |

The results of the testing reported in Table 4 show that the replacement of 30% of the resin with high ratio silicate provided a consistent level of scrub resistance while replacement of 30% of the resin with water resulted in a significant lessening of scrub resistance.

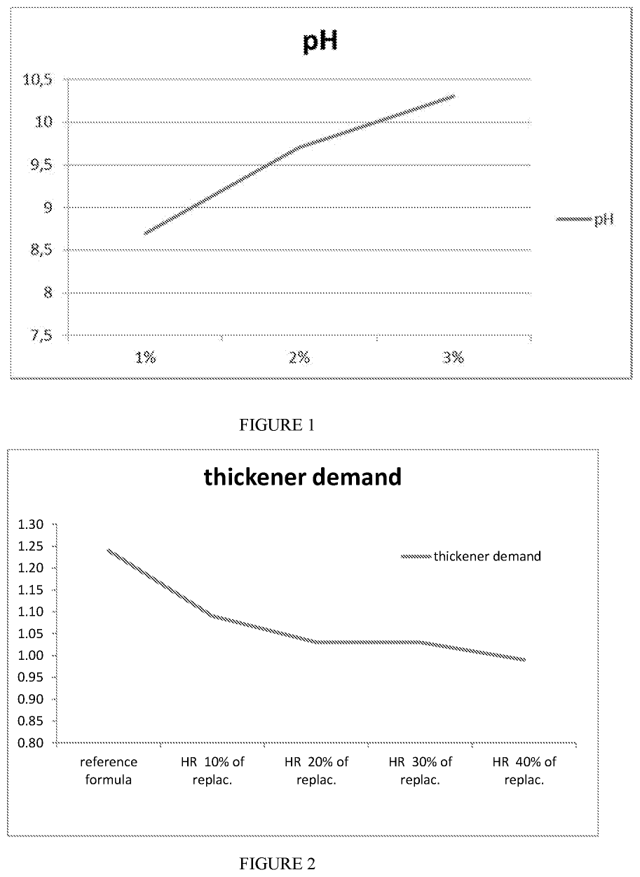

High ratio silicates have the added benefit of serving as a pH stabilizer, providing an additional benefit for their use in architectural paints. Tests were conducted to determine the pH of paint solutions at various levels of high ratio silicate dosing. Dosage levels of 1%, 2%, and 3% of the total weight of the formulation (corresponding to replacement levels of 8.3%, 16.7%, and 25% of resin, respectively, based on the formulation set forth in Table 1) were tested. The results of these tests are set forth in Table 5 below and plotted in FIG. 1.

TABLE 5

| | High ratio | |
|---|---|---|
| | silicate dosage | pH |
| High ratio | 1% | 8.7 |
| High ratio | 2% | 9.7 |
| High ratio | 3% | 10.3 |

To further test the pH stabilization effect of the high ratio silicates, a series of 5 paint compositions were prepared having different amounts of resin replaced by high ratio silicate. A reference formula was prepared and 4 additional formulas were prepared having, respectively, 10%, 20%, 30%, and 40% of the resin replaced by high ratio silicate. As the amount of high ratio silicate increased, the required dosage of thickener was reduced. The results of these tests are set forth in Table 6 below and plotted in FIG. 2.

TABLE 6

| Paint | Thickener dosage |
|---|---|
| reference formula | 1.24 |
| HR 10% of replac. | 1.09 |
| HR 20% of replac. | 1.03 |
| HR 30% of replac. | 1.03 |
| HR 40% of replac. | 0.99 |

The results of the pH testing show that the high ratio soluble silicate stabilizes the pH of the paint solution, eliminating the need for a separate pH stabilizer. This also leads to a corresponding reduction in the amount of thickener needed in the paint composition.

The examples in the tables above illustrate one embodiment of the present invention. Other variations and combinations of components and of quantities in a liquid or powder form are within the scope of this invention. Solely as an example of another paint composition and not intending to be limiting in any respect, Table 7 below illustrates a typical composition used in Mexico.

TABLE 7

| | Weight | Weight |
|---|---|---|
| | (%) | (kg) |
| pH stabilizer (ammonia) | 0.06% | 0.60 |
| Dispersant | 0.17% | 1.70 |
| Antifoam | 0.08% | 0.80 |
| Bactericide | 0.30% | 3.00 |
| Coalescing agent | 0.50% | 5.00 |
| Thickener (cellulose) | 0.30% | 3.00 |
| Fungicide | 0.26% | 2.60 |
| Resin (Vinyl acrylic) | 11.96% | 119.60 |
| Water | 46.89% | 468.90 |
| TiO₂ (R902 Chemours) | 8.28% | 82.80 |
| Calcium carbonate | 8.75% | 87.50 |
| Diatomita | 2.21% | 22.10 |
| kaolin (Brasilminas) | 20.24% | 202.40 |

Any documents referenced above are incorporated by reference herein. Their inclusion is not an admission that they are material or that they are otherwise prior art for any purpose.

Although the invention is illustrated and described herein with reference to specific embodiments, the invention is not intended to be limited to the details shown. Rather, various modifications may be made in the details within the scope and range of equivalents of the claims and without departing from the invention.

Although the invention is illustrated and described herein with reference to high ratio soluble sodium and potassium silicates, the invention is not intended to be limited thereto. Rather, the invention can be applied to other high ratio soluble silicates.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Although the present invention has been described with respect to its application in architectural coatings, it is to be distinctly understood that the present invention can be used in connection with other paints.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An architectural coating composition comprising a resin wherein a portion of the resin in the composition is replaced with a high ratio soluble silicate.

2. The coating composition of claim 1 wherein the high ratio soluble silicate stabilizes the pH of the composition.

3. The composition of claim 2 having a silicon dioxide to alkali metal oxide weight ratio that is higher than 3.3 for sodium silicate and higher than 2.4 for potassium silicate.

4. The composition of claim 3, wherein the soluble silicate is present in an amount ranging from 0.1% to 50% of the total composition.

5. The composition of claim 4 further comprising at least one of a filler, resin binder and thickener.

6. The composition of claim 1 having a silicon dioxide to alkali metal oxide weight ratio that is higher than 3.3 for sodium silicate and higher than 2.4 for potassium silicate.

7. The composition of claim 1, wherein the soluble silicate is present in an amount ranging from 0.1% to 50% of the total composition.
